(19) United States
(12) Patent Application Publication
(10) Pub. No.: US 2026/0349461 A1
(43) Pub. Date: Nov. 5, 2026

(54) METHOD FOR MANUFACTURING A CONTROL DEVICE

(71) Applicant: APEM, Caussade (FR)

(72) Inventor: Cédric MORA, L'honor De Cos (FR)

(73) Assignee: APEM, Caussade (FR)

(21) Appl. No.: 19/659,864

(22) Filed: Apr. 27, 2026

(30) Foreign Application Priority Data
Apr. 30, 2025 (FR) FR2504585

(51) Int. Cl. G05G 1/06; B29C 45/00; B29C 45/37; B29L 31/46

(52) U.S. Cl. CPC G05G 1/06; B29C 45/0053; B29C 45/372; B29C 45/0025; B29C 2045/0079; B29K 2995/0074; B29K 2995/0097; B29L 2031/463

(57) ABSTRACT

This invention relates to a method for manufacturing a control device comprising a gripping stick. The method comprises:
manufacturing a rigid shell (10, 20) defining a part of the stick by injection of a plastic material into a mold (50) forming a cavity (51), said cavity having a recessed and/or raised mold texture on at least a part (52) of an inner face, so as to form a shell texture complementing said mold texture on an outer face of the shell,
applying an adhesion layer (30) to the shell,
applying a coating (40) to the adhesion layer (30).

### FIELD OF THE INVENTION

This invention relates to a method for manufacturing a control device and a control device for a utility vehicle.

### TECHNICAL BACKGROUND

To control a utility vehicle or an item of building site machinery, for example an excavator or a loader, control devices in the form of a movable stick are used. These devices generally comprise at least one control element, for example a pushbutton, a wheel or a lever, making it possible to control a function of the vehicle or a work tool adaptable to the vehicle.

The control devices must withstand harsh environments, for example temperature variations which may range from −40 to 85 °C and more, saline mist, chemicals such as hydrocarbons, and also substances often present on the hands of an operator such as sweat, hydroalcoholic gel, cream or coffee. In addition, a good grip of the control device is necessary to ensure safe and comfortable handling.

To meet these constraints, known devices typically include a coating made of an elastomer such as polyurethane, thermoplastic elastomer (TPE) or nitrile rubber. The use of elastomers makes it possible to increase the friction between the movable stick and the hand of a user with or without gloves, and thus to increase the adhesion of the control device.

Control devices have an ergonomic shape, with curves and surfaces adapted to the hand of the user. This makes it possible to ensure comfortable handling during long periods of work, while offering better control. Some models include areas of a shape adapted to the fingers and thumb to improve precision of movement still further.

Some control devices have a textured surface, with grooves or raised patterns on the surface, to increase friction and avoid the hand of the operator slipping, even under humid or dirty conditions.

In a known manner, a method of overmolding or by two-shot injection is used to manufacture the stick of such control devices. Such a manufacturing method comprises the injection of an elastomer on a product base to establish a permanent and durable connection. In the case of overmolding in a second mold, the surface of the product base is typically cleaned and/or heated in an oven to improve the adhesion of the elastomer to said surface. Two-shot injection in a single mold makes it possible to work under controlled temperature conditions and avoiding any contamination. However, this method requires very specific and very expensive molds and injection machines.

However, the two-shot injection overmolding method has a certain number of drawbacks.

The adhesion between the material of the product base, typically a rigid plastic material, and the overmolded elastomer material is difficult to control and debonding of the elastomer may occur. This gives rise to handling problems and discomfort for the user of the control device. The adhesion in particular depends on the chemical compatibility of the materials of the product base and of the overmolded material. In the event of incompatibility, delamination or mechanical defects in the finished part may also occur.

In the event of debonding or peeling between the injected material and the product base, the use of the control device becomes very difficult. This phenomenon may lead to considerable risk during use, particularly in heavy building-site vehicles.

Moreover, the materials of the product base and of the injected portion often have different thermal expansion coefficients. In the event of temperature variations, particularly during cooling after overmolding, this difference causes mechanical strain within the part, which can lead to deformations, cracks and/or problems of alignment of the different elements of the control device.

Overmolding moreover requires very good control of the injection temperature in order to avoid deformation or damage to the rigid material of the product base during the injection of the elastomer material.

Finally, the molds used for overmolding are very complex and require sealed closing systems, to avoid flash and guarantee a good alignment between the base material and that of the overmolding. For example, in the case of control devices formed of two overmolded half-shells, flash along the parting line is often inconvenient for the user and perceived as an indication of poor quality.

In conclusion, the manufacturing of a control device by overmolding is a method of several steps, requiring complex tools with a high manufacturing cost, and stringent controls to ensure the quality of the adhesion and finish of each part. Any discards and/or the need to rework parts after molding increase the manufacturing cost still further.

### SUMMARY OF THE DISCLOSURE

One aim of the invention is to provide a method for manufacturing a control device that is easy to implement, making it possible to manufacture a control device that is robust, reliable and easy to handle.

For this purpose, the invention makes provision for a method for manufacturing a control device comprising a gripping stick, said method comprising
manufacturing a rigid shell defining a part of the stick by injection of a plastic material into a mold forming a cavity, said cavity having a recessed and/or raised mold texture on at least a part of an inner face, so as to form a shell texture complementing said mold texture on an outer face of the shell,
applying an adhesion layer to the shell,
applying a coating to the adhesion layer.

According to other advantageous but optional features of said method, taken separately or in combination:
the applying of the adhesion layer is done by spraying or dipping;
the applying of the coating is done by spraying or dipping;
the plastic material is a thermoplastic, preferably reinforced polyamide or reinforced acrylonitrile butadiene styrene/polycarbonate;
the method further comprises, before the manufacturing of the shell, the placing of an insert block in the mold, said insert block having a recessed and/or raised block texture making it possible to produce a second texture on a part of the surface of the shell;
the method further comprises the assembling of at least two shells to form the gripping stick and the installing of at least one control element in a cavity formed by said shells.

Another subject of the invention relates to a control device for a vehicle or item of machinery, said device comprising:
a shell made of rigid plastic having a texture on at least a part of an outer face,
an adhesion layer disposed on the outer face of the shell,
a coating layer disposed on the adhesion layer, and
at least one control element arranged in the shell.

According to other advantageous but optional features of said device, taken separately or in combination:
the coating comprises polyurethane;
the thickness of the coating is between 30 to 60 μm, preferably 50 μm;
the thickness of the adhesion layer is between 5 and 15 μm;
the coating has a soft-touch effect at least in an area having a texture;
a first area of the outer face of the shell, intended to receive a palm of a hand and/or at least one finger of a user, has a texture;
the outer face of the shell comprises at least two areas having two different textures.

### BRIEF DESCRIPTION OF THE FIGURES

Other features and advantages of the invention will become apparent from the following detailed description, with reference to the appended drawings, in which:

FIG. 1 shows a control device according to the invention.

FIGS. 2A, 2B, 2C and 2D show examples of textures.

FIGS. 3A, 3B and 3C show examples of shells having textures.

FIG. 4 shows a mold for forming a shell.

FIG. 5 illustrates a structured face of a shell.

FIG. 6 illustrates the structured face of FIG. 5 with an adhesion layer.

FIG. 7 illustrates a stack of layers on the structured face of a shell of FIG. 5.

For reasons of legibility of the figures, the illustrated elements are not necessarily shown to scale.

### DETAILED DESCRIPTION OF EMBODIMENTS

FIG. 1 illustrates a control device for utility vehicles according to an embodiment.

The control device comprises a shell 10 made of rigid plastic forming at least a part of a stick shaped to be grasped by an operator. The shell is typically made of thermoplastic, for example polyamide or acrylonitrile butadiene styrene/polycarbonate. Preferably, the thermoplastic is reinforced with glass fiber, carbon or mineral fibers in order to give the stick suitable rigidity and mechanical stability.

One or more control elements 11 are disposed in the shell and may be actuated by the hand of a user grasping the stick. For example, these control elements may be pushbuttons, rotary wheels, levers or toggle switches, disposed in areas easily accessible by the fingers of the user during the handling of the stick.

The shell may be made of a single part or be composed of several assembled elements. The shell is typically hollow to house cables connected to at least one control element. On its outside, the shell has an ergonomic shape suitable for promoting good handling by the operator. Over at least a part 12 of its outer surface, the shell has a texture facilitating the gripping of the stick and increasing the friction between the hand and the stick, to avoid the hand of the operator slipping during use of the control device.

For the purposes of graphic representation, the texture is illustrated only over a part of the area 12 in the figures. However, the texture is distributed continuously over the entirety of each area 12. Naturally, the size and shape of the areas may vary according to the shape and functionality of the control device.

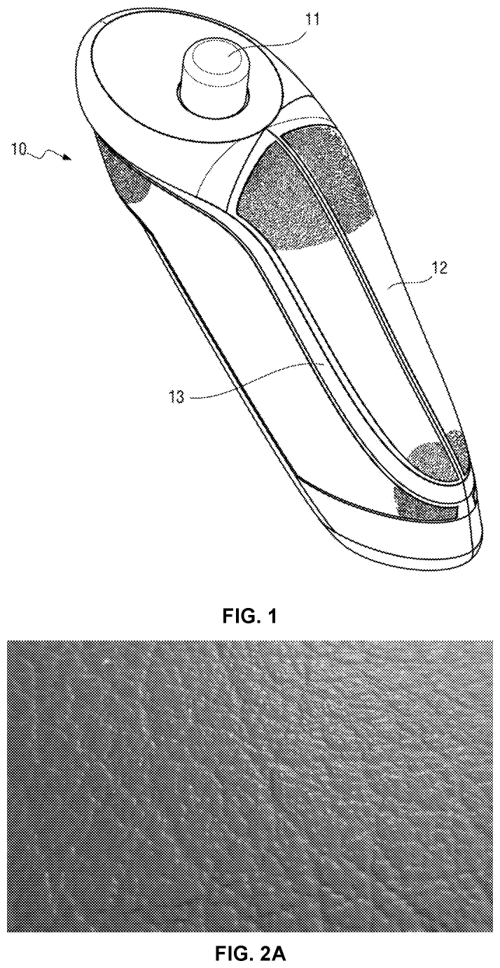

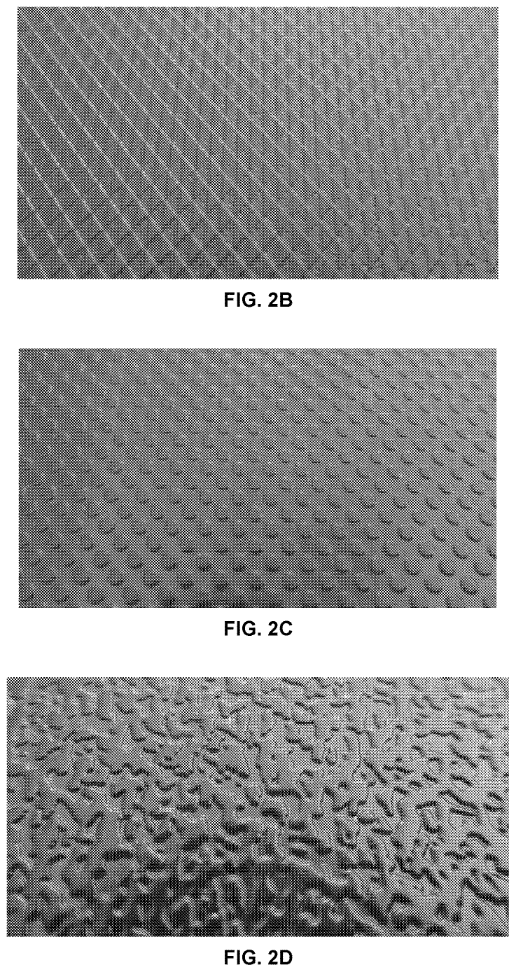

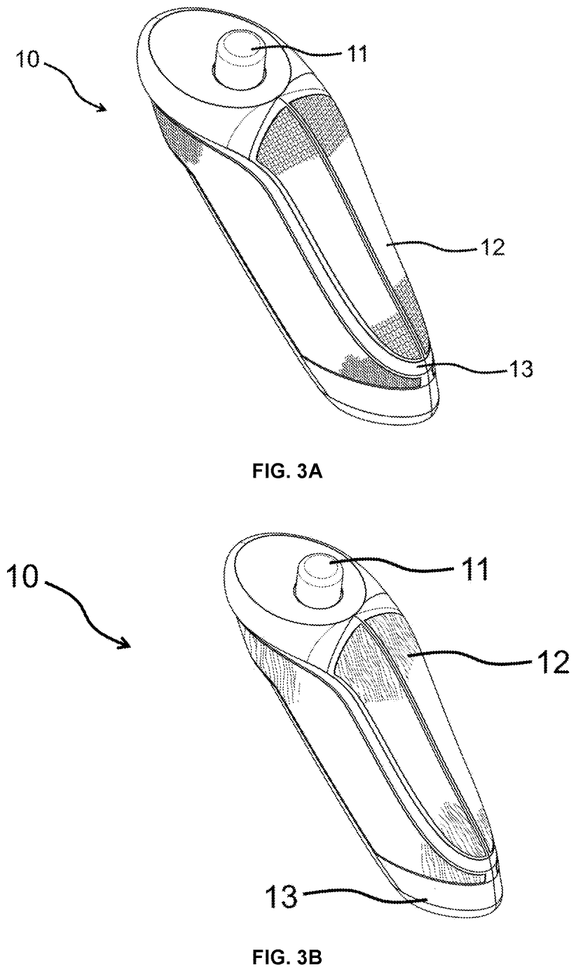

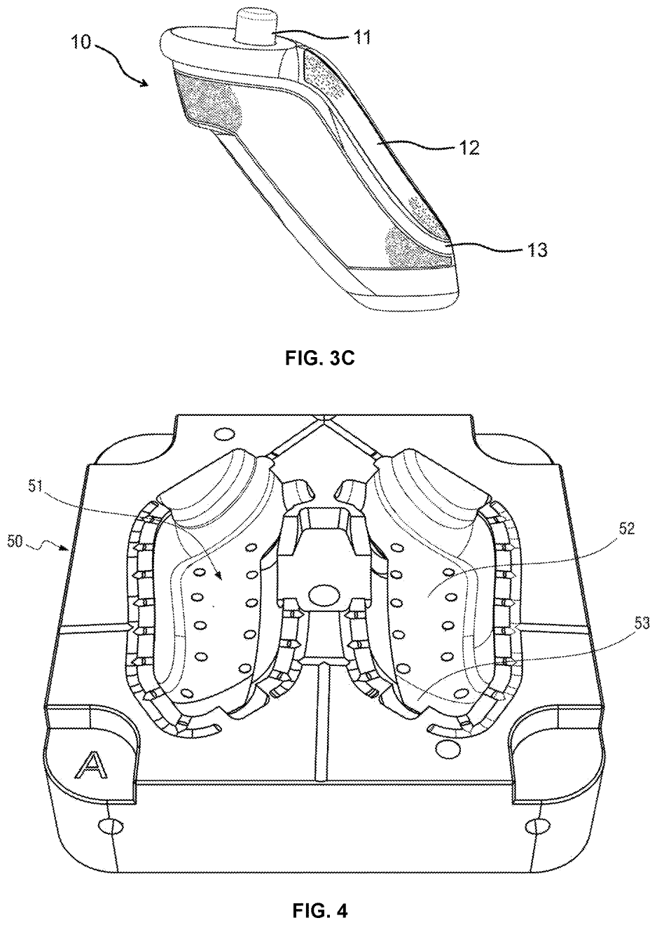

The texture is a uniform or non-uniform texture of the plastic surface and may comprise the presence of very varied patterns which are raised and/or recessed with respect to a base geometry of the surface of the shell. Typically, the texture has a height or depth between 0.1 and 1 mm. Examples of textures are illustrated in FIGS. 2A to 2D. Shells having other textures are shown in FIGS. 3A to 3C. For example, with reference to FIG. 2A, the texture may have a skin pattern. In other examples, the texture may comprise round protrusions, as illustrated in FIG. 2B, a geometrical pattern as illustrated in FIG. 2C, angular protrusions or structures inspired by surfaces of other materials, for example a raised pattern imitating a woven structure as illustrated in FIG. 3A, a wooden surface as illustrated in FIG. 3B, or a non-uniform pattern as illustrated in FIGS. 2D and 3C. The texture may have a uniform pattern, formed by the repetition of a same basic pattern, or a non-uniform pattern.

The outer face of the shell may have a texture over its whole extent. Alternatively, the shell has smooth areas 13 and only a part of its outer face 12 has a texture. In this case, the texture is preferably disposed in an area in which good gripping is desired, typically an area in which the user may set the palm of his hand or one or more fingers.

In certain embodiments, several separate areas of the outer face of the shell have identical or different textures. Different textures may, for example, feature reliefs of varying heights in order to enhance grip in areas with higher relief, while providing a more pleasant tactile feel in areas with reduced relief height.

All the areas requiring good adhesion of the user's hand preferably have a texture, making it possible to increase the friction between the hand and the respective area of the stick. Areas without a texture are for example arranged around a control element or along an edge on the stick and may make it possible to avoid said areas becoming dirty too quickly.

The plastic shell is covered with an adhesion layer and a coating layer. The whole formed by the adhesion layer and the coating layer is applied so as not to completely fill the recesses formed by the texture. In other words, the texture remains visible and perceptible to the touch after application of the coating layer.

The adhesion layer is arranged directly on the outer layer of the shell and promotes the adhesion of the coating layer to the plastic shell. The adhesion layer has a thickness between 5 and 15 μm. This thickness makes it possible to preserve the structure of the texture on the outer face of the shell, while making the adhesion layer even and continuous enough to optimize the adhesion of the coating layer to the plastic shell.

The coating is typically a polyurethane-based product and has a thickness between 30 and 60 μm. Such a thickness makes it possible to ensure an even coating layer and to preserve the structure of the texture on the outer face of the coating.

Polyurethane is a resistant and elastic material, making it possible to produce an outer surface with a matt appearance and a pleasant feel of “soft-touch” type. Typically, a black color or a transparent coating on black plastic is used, which makes the stick more robust to dirt from products frequently present in a building-site environment. In other embodiments, a colored coating may be used for better visibility of the control device.

The coating furthermore makes it possible to cover any visual defects that may occur during the molding of the plastic shell, for example splay, burn marks, flow lines, weld lines or glossy areas.

A description will now follow of a method for manufacturing a control device according to the invention.

With reference to FIG. 4, the manufacturing of the control device requires an injection mold 50 forming a cavity 51 for the plastic shell that is to be produced. At least certain areas 52 of the cavity 51 have a raised and/or recessed structure in order to form a texture complementing the raised and/or recessed structure in the plastic shell to be produced. For the legibility of the figure, the texture has not been shown. Optionally, one or more areas 53 of the cavity are smooth, with no raised and/or recessed structure. In some cases, different structures are produced in several areas of the mold. It is also possible to produce an unstructured temporary mold and to incorporate an insert block bearing a raised and/or recessed structure into said mold to obtain the cavity for the texture on the incorporated insert block.

The use of a specific insert block for a textured portion makes it possible to easily modify the texture by changing one insert block for another, and thus to produce control devices with different textures via a shared mold, with suitable slabs for each desired texture.

The raised and/or recessed structure is typically produced by chemical etching or laser engraving. Texturing by chemical etching makes it possible to produce non-uniform and random textures, often having a natural appearance and offering a good grip in the hand. Texturing by laser allows the production of a large number of different textures, particularly uniform, geometrical textures, and imitating any surface type.

The height of the raised pattern is between 0.1 and 1 mm, which makes it possible to provide a structure promoting good gripping of the stick, limiting the risks of defects and voids during the injection molding.

The texture in the mold may be adapted according to the texture desired for the gripping stick to be manufactured. For example, the texture of the mold may be coarser than the texture desired on the gripping stick in order to take into account the thicknesses of the adhesion layer and of the coating and any filling of certain structures by the products used for said layers.

The shell may be made as a single part. For the manufacturing of more complex sticks, the shell may be made of several molded parts which are then assembled, for example two half-shells and/or one or more parts intended to house control elements. This method makes it possible to incorporate internal mechanisms or mechanisms of more sophisticated shapes.

Each mold is assembled in an injection press. Typically, the assembly comprises at least the assembly of two parts, each forming a cavity of a shell or of a part of the shell (for example a half-shell) of the control device. In some cases, the assembly comprises the insertion of one or more slabs including a raised or recessed structure to form an area having a texture.

The plastic shell or shell part is made by injecting a thermoplastic material into the mold. Typically, the thermoplastic material is injected into the mold with glass, mineral or carbon reinforcement fibers.

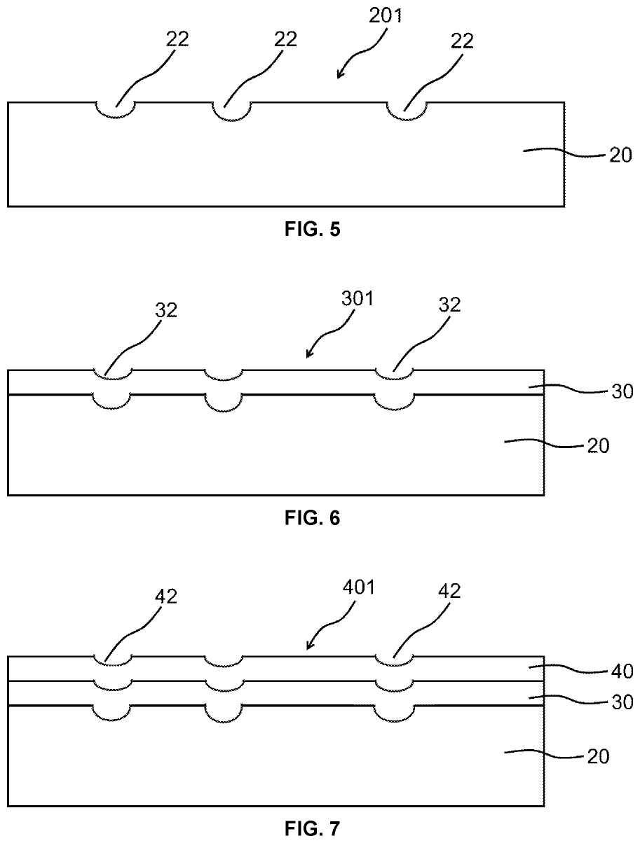

After the cooling and unmolding of the shell, the adhesion layer is applied. The adhesion layer is typically applied by spraying a precursor of the adhesion layer on the outer face of the shell. The spraying makes it possible to produce a layer of the thickness between 5 and 15 μm evenly on the entire outer face of the shell. FIG. 5 schematically illustrates a texture in the form of recesses 22 in a surface 201 of a shell 20. As illustrated on FIG. 6, the texture of the outer face is preserved on the outer face 301 of the adhesion layer 30. The recesses 32 in the structure of the texture are therefore not entirely filled by the material of the adhesion layer 30.

The precursor is typically an adhesion primer mixed with a curing agent. After application, the solvent present in the mixture is evaporated, for example during approximately 5 to 10 minutes at ambient temperature, i.e. at approximately 20 °C. In a second step, the adhesion layer is cured, for example by a chemical reaction between the adhesion primer and the curing agent at 70 °C for 30 min. Subsequent drying allowing the evaporation of solvent residue may be necessary.

Subsequently, with reference to FIG. 7, the coating 40 is applied to the finished adhesion layer 30. Illustratively and without limitation, a precursor in the form of a dispersion or suspension of polyurethane is applied by spraying.

As illustrated in FIG. 7, the texture of the outer face is preserved on the outer face 401 of the coating 40. The recesses 42 in the texture structure are therefore not entirely filled with the coating material 40.

After applying the coating, the solvent present in the dispersion or suspension is evaporated, for example for approximately 10 minutes at ambient temperature. In a second step, a heat treatment can then be carried out, for example of 70 °C for 60 min. A subsequent drying allowing the evaporation of any solvent residue may be necessary.

In the case of a shell composed of several parts, the application of the adhesion layer and of the coating is preferably done on each part before assembly of the shell.

To offer a wide range of control devices without the need to manufacture additional injection molds, provision can also be made for using other parts manufactured in the same mold for use without any coating.

After application of the coating, one or more control elements may be incorporated into the plastic shell. These elements are typically electrically connected to cables passing through a hollow inside the stick and may be connected to a utility vehicle or an item of building site machinery to be driven.

1. A method for manufacturing a control device comprising a gripping stick, the method comprising
manufacturing a rigid shell defining part of the stick by injecting a plastic material into a mold forming a cavity, said cavity having a recessed and/or raised mold texture on at least a part of an inner face, so as to form a shell texture complementing said mold texture on an outer face of the shell,
applying an adhesion layer to the shell, and
applying a coating to the adhesion layer.

2. The method of claim 1, wherein the applying of the adhesion layer is done by spraying or dipping.

3. The method of claim 1, wherein the applying of the coating is done by spraying or dipping.

4. The method of claim 1, wherein the plastic material is a thermoplastic.

5. The method of claim 4, wherein the plastic material is reinforced polyamide or reinforced acrylonitrile butadiene styrene/polycarbonate.

6. The method of claim 1, further comprising, before manufacturing the shell, placing an insert block in the mold, said insert block having a recessed and/or raised block texture different from the mold texture.

7. The method of claim 1, further comprising assembling at least two shells to form the gripping stick and installing at least one control element in a cavity formed by said shells.

8. A control device for a vehicle or item of machinery, comprising
a shell made of rigid plastic having a texture on at least a part of an outer face,
an adhesion layer disposed on the outer face of the shell,
a coating layer disposed on the adhesion layer, and
at least one control element arranged in the shell.

9. The control device of claim 8, wherein the coating comprises polyurethane.

10. The control device of claim 8, wherein the coating has a thickness between 30 and 60 μm.

11. The control device of claim 8, wherein the adhesion layer has a thickness between 5 and 15 μm.

12. The control device of claim 8, wherein the coating has a soft-touch effect at least in an area having a texture.

13. The control device of claim 8, wherein a first area of the outer face of the shell, intended to receive a palm of a hand and/or at least one finger of a user, has a texture.

14. The control device of claim 8, wherein the outer face of the shell comprises at least two areas having two different textures.
